(19) United States
(12) Patent Application Publication
(10) Pub. No.: US 2011/0297654 A1
(43) Pub. Date: Dec. 8, 2011

(54) LASER WELDING APPARATUS

(75) Inventors: Nobuhiro Yoshikawa, Kanagawa (JP); Toshihiko Ishizuka, Kanagawa (JP)

(73) Assignee: Nissan Motor Co., Ltd., Yokohama, Kanagawa (JP)

(21) Appl. No.: 13/201,748

(22) PCT Filed: Feb. 24, 2010
(86) PCT No.: PCT/IB2010/000370

§ 371 Date: Aug. 16, 2011

(30) Foreign Application Priority Data
Mar. 13, 2009 (JP) 2009-061724

(51) Int. Cl. B23K 26/06; B23K 26/04

(52) U.S. Cl. 219/121.62; 219/121.81

(57) ABSTRACT

A laser welding apparatus is provided with a multiple axis robot having an arm and a scanner attached to a tip end of the arm of the multiple axis robot. The scanner includes an optical system that emits a laser beam onto a work piece. The scanner includes a preset coordinate system with an origin of the coordinate system coinciding with an intersection point between an optical axis of the laser beam and a fixed element of the optical system.

### CROSS-REFERENCE TO RELATED APPLICATIONS

This application claims priority to Japanese Patent Application No. 2009-061724, filed on Mar. 13, 2009. The entire disclosure of Japanese Patent Application No. 2009-061724 is hereby incorporated herein by reference.

### BACKGROUND

1. Field of the Invention

The present invention generally relates to a laser welding apparatus that can accomplish laser welding work at a high speed. More specifically, the present invention relates to a laser welding apparatus that can accomplish laser welding at a high speed.

2. Background Information

In recent years, the automobile industry is assembling vehicle bodies using laser welding. Laser welding is performed using a multiple axis robot having a scanner attached to a tip end (working end) thereof. A laser beam is emitted from the scanner. Laser welding generally requires high-speed performance and the laser beam to be emitted with a high degree of positional accuracy. For example, a laser welding apparatus is disclosed in Japanese Laid-Open Patent Publication No. 2006-187803, which presents technology for satisfying these requirements by operating a multiple axis robot in conjunction with a scanner that moves along two axes (directions).

### SUMMARY

It has been discovered that with the technology presented in the patent publication cited above, an origin of a coordinate system of the scanner is set to coincide with a rotational center axis of a scanning mirror contrived to move along two axes on an optical path of the scanner. The multiple axis robot can ascertain where the origin of the scanner coordinate system is at any time based on the origin of a coordinate system of the robot. A robot control device executes combined control of the arm of the multiple axis robot and of an angle and a focal point distance of the scanning mirror.

Since the origin of the scanner coordinate system is set to lie on a rotational axis of the scanning mirror, the position of the origin of the scanner coordinate system ascertained by the multiple axis robot is sometimes different from the actual position of the origin of the scanner coordinate system due to the effects of play in the moving parts serving to move the scanning minor along two axes and the effects of how precisely the apparatus is assembled. If such a difference occurs, then the position where the laser is hits the work piece will be offset from the position actually being aimed for and the accuracy with which the laser beam is positioned during laser welding will decline.

Also, since the arm of the multiple axis robot and the angle and focal distance of the scanning mirror are all controlled by the same robot control device, there is a limit to the high speed performance of the laser welding and it is difficult to execute laser welding at higher speeds.

One object of the present invention is to provide a laser welding apparatus that can accomplish laser welding work at a high speed.

In view of the state of the known technology, one aspect of the present invention is to provide a laser welding apparatus that comprise a multiple axis robot having an arm and a scanner attached to a tip end of the arm of the multiple axis robot. The scanner includes an optical system that emits a laser beam onto a work piece. The scanner includes a preset coordinate system with an origin of the coordinate system coinciding with an intersection point between an optical axis of the laser beam and a fixed element of the optical system.

### BRIEF DESCRIPTION OF THE DRAWINGS

Referring now to the attached drawings which form a part of this original disclosure:

FIG. 1 is a simplified schematic view of a laser welding apparatus according to one illustrated embodiment;

FIG. 2 is a simplified schematic view showing the scanner of FIG. 1 in more detail;

FIG. 3 is a plot illustrating a relationship between a movement distance of an expander lens and a distance from a focusing lens to a working point (laser beam processing point);

FIG. 4 is a flowchart of control operations executed by the central processing unit of the laser welding apparatus according to the illustrated embodiment; and

FIG. 5 is a sketch for explaining the processing executed by the central processing unit in carrying out the operation flowchart shown in FIG. 4.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

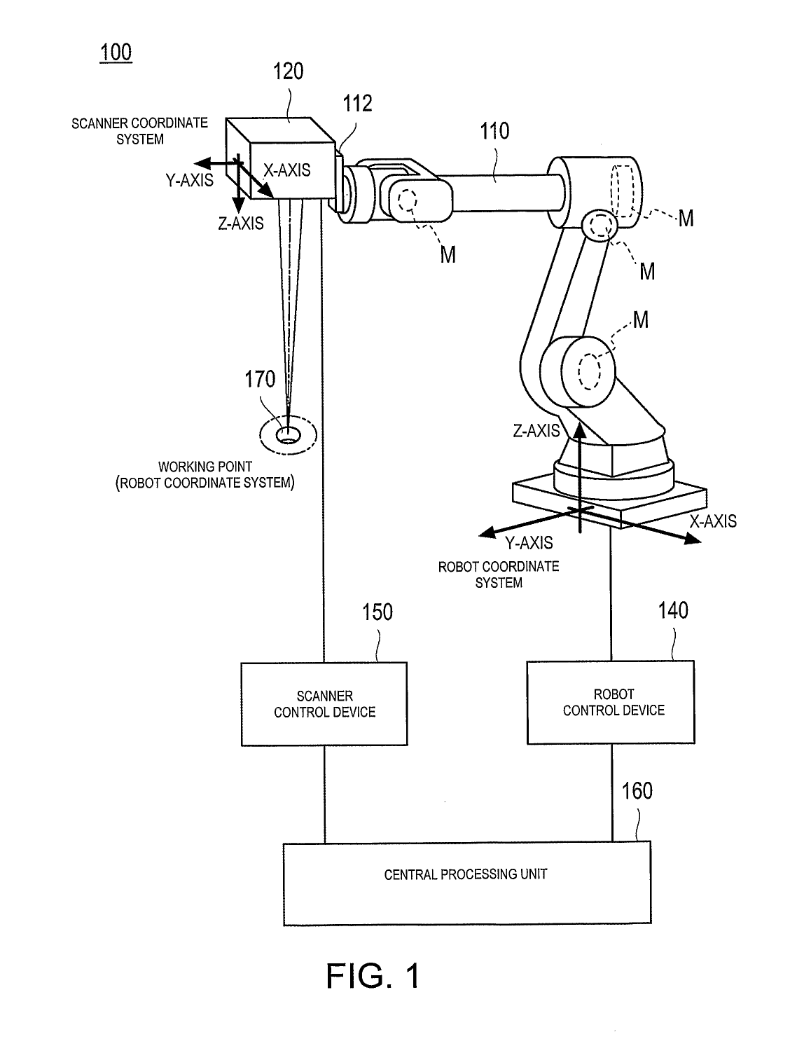

Referring initially to FIG. 1, a laser welding apparatus 100 is schematically illustrated in accordance with one illustrated embodiment. The laser welding apparatus 100 mainly includes a multiple axis robot 110, a scanner or laser processing head 120, a robot control device 140, a scanner control device 150 and a central processing unit 160. The multiple axis robot 110 has an arm with a plurality of articulating sections, as shown in FIG. 1. The multiple axis robot 110 is a six-axis robot (also called “multi jointed robot”) with the joints between the articulating sections defining the six axes of movement. A motor M (e.g., an AC servomotor) and an encoder (not shown) are provided at each axes of the joints between the articulating sections. Thus, the multiple axis robot 110 has six AC servomotors M (only four indicated in FIG. 1) and six degrees of freedom. The multiple axis robot 110 operates based on a unique robot coordinate system. As a result, the tip end of the arm, i.e., the laser processing head or scanner 120, can be moved in various directions by changing the position and posture of the multiple axis robot 110. The AC servomotors M are configured and arranged to rotate by an amount corresponding to the movement amount specified in a command issued from the robot control device 140. The pulse signals outputted from the pulse encoders are fed to the robot control unit 52. Needless to say, the motors M and the encoders used in the laser welding apparatus 100 are not limited to these specific devices and it is also possible to use devices other than servomotors and pulse encoders.

The scanner 120 constitutes a laser beam emitting section of the laser welding apparatus 100. The scanner 120 is attached to a working end 112 of the arm of the multiple axis robot 110. The scanner 120 is arranged to emit a laser beam onto a working point 170 (laser irradiation position) of a work piece, e.g., a door, a hood, a trunk, or other part of a car. A portion of the work piece where the laser beam strikes is melted and welded. The scanner 120 operates based on a unique scanner coordinate system. The coordinates of the working point 170 are specified according to the robot coordinate system. Therefore, the scanner 120 is equipped with an optical system arranged to emit the laser beam accurately onto the working point 170. By operating the optical system, the laser beam is scanned in an X-axis direction and a Y-axis direction (robot coordinate system) and the position of a focal point of the beam is adjusted in a Z-axis direction (robot coordinate system). The scanner 120 is equipped with three AC servomotors to move the laser beam in three directions, i.e., an X-axis direction, a Y-axis direction and a Z-axis direction (scanner coordinate system). Thus, the scanner 120 can vary the position where the laser beam is focused in three dimensions. A method by which the scanner 120 converts between the robot coordinate system and the scanner coordinate system and a detailed description of the constituent features of the scanner 120 will be explained later.

The robot control device 140 sets the origin of the coordinate system of the scanner 120 (scanner coordinate system) to coincide with an intersection point between an optical axis of the laser beam and an element among the constituent elements of the optical system of the scanner 120 that is fixed within the optical system. By setting the origin of the coordinate system of the scanner 120 to coincide with an intersection point between an optical axis of the laser beam and a constituent element of the optical system of the scanner 120 that is fixed within the optical system and using a computational method described later to execute control in a focal distance direction, the position of the scanner 120 can be determined using a linear computation. In other words, a movement amount of the expander lens 123 (described later) in an optical path direction and a change amount of the focal point distance are computed using a linear approximation. As result, the multiple axis robot 110 can be controlled more easily with respect to the working point 170 and highly precise welding work can be accomplished at a high speed. Thus, the control of the multiple axis robot 110 is simpler and the multiple axis robot 110 can trace taught points accurately and at a high speed. The robot control device 140 controls the operation of the six AC servomotors of the multiple axis robot 110 such that the origin of the coordinate system of the scanner 120 passes along a taught path of the multiple axis robot 120 that has been stored in advance.

The scanner control device 150 controls the operation of the three AC servomotors of the optical system of the scanner 120 such that a laser beam emitted from the scanner 120 shines accurately onto the working point 170 of the work piece.

The central processing unit 160 sends synchronized operation commands (e.g., at the same control cycle time interval and the same timing) to the robot control device 140 and the scanner control device 150. The robot control device 140 and the scanner control device 150 process the operation commands from the central processing unit 160 at the same control speed and the same control cycle time. In this way, the multiple axis robot 110 and the scanner 120 are operated in parallel as if they were being driven by a single control device.

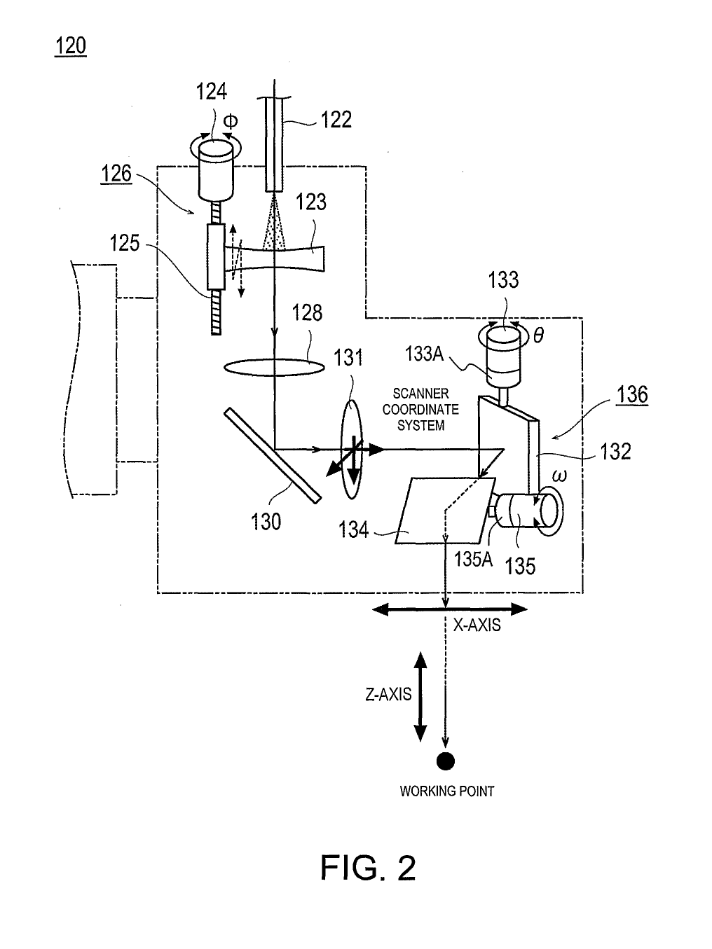

FIG. 2 is a schematic view showing the scanner 120 of FIG. 1 in more detail. The scanner 120 includes an optical fiber 122, an expander lens 123, a focal point position adjusting device 126. The focal point position adjusting device 126 is equipped with an AC servomotor 124 and a ball screw 125 for driving the expander lens 123. The scanner 120 further includes a collimating lens 128, a reflecting mirror 130, a focusing lens 131 and a laser beam scanning device 136. The laser beam scanning device 136 is equipped with a first scanning mirror 132, an AC servomotor 133 for rotating the first scanning mirror 132, a second scanning mirror 134, and an AC servomotor 135 for rotating the second scanning mirror 134. The optical fiber 122 is arranged and configured to shine a laser beam toward the expander lens 123. The laser beam is generated by a laser oscillator (not shown).

The focal point position adjusting device 126 serves to move the expander lens 123 along the direction of an optical axis of the laser beam (vertical direction indicated with an arrow in FIG. 2). The expander lens 123 is arranged to be moved along the direction of the optical axis of the laser beam and serves adjust the focal distance. A spread angle of the laser beam emitted from the optical fiber 122 changes according to the position of the expander lens. As a result, the focal distance of the laser beam changes and the working point moves along the direction of the Z axis shown in FIG. 2. The expander lens 123 is moved by the AC servomotor 124 and the ball screw 125.

The collimating lens 128 serves to collimate the spread laser beam passing from the expander lens 123. The reflecting mirror 130 redirects the collimated laser beam exiting the collimating lens 128 toward the laser beam scanning device 136. In the laser beam scanning device 136, the laser beam arriving from the reflecting mirror 130 is first reflected by the first scanning mirror 132 and then reflected by the second scanning mirror 134 so as to be directed to the working point. The first scanning mirror 132 is connected to a rotary shaft of the AC servomotor 133 such that it can be turned by the AC servomotor 133 about a rotational center axis of the rotary shaft. When the first scanning minor 132 is turned, the position where the laser beam strikes moves along the direction of the X axis shown in FIG. 2, thereby changing the position of the working point. The second scanning mirror 134 is connected to a rotary shaft of the AC servomotor 135 such that it can be turned by the AC servomotor 135 about a rotational center axis of the rotary shaft. When the second scanning mirror 134 is turned, the position where the laser beam strikes moves in along the direction of the Y axis shown in the figures (in FIG. 2, the Y axis is perpendicular to the plane of the paper), thereby changing the position of the working point.

Thus, by controlling (moving) the expander lens 123, the first and second scanning mirrors 132 and 134 in accordance with the three-dimensional coordinates of the working points of a work piece, the laser beam can be controlled to accomplish accurate laser welding on a work piece whose working points vary in three dimensions.

When the position of the working point varies only slightly in a Z-axis direction, it is not necessary to move the expander lens 123 if an output density of the laser beam shone onto the working point will vary only within a prescribed range.

A reflectivity of the first and second scanning mirrors 132 and 134 with respect to the laser light varies depending on a reflection angle due to the effects of a state of a surface coating provided on the mirrors 132 and 134. In order to obtain the necessary output density of laser light at the working point, the reflection angle is limited to be within a prescribed angular range. The angular range is typically approximately ±10 degrees.

The AC servomotor 124 serving to drive the expander lens 123, the AC servomotor 133 serving to drive the first scanning mirror 132, and the AC servomotor 135 serving to drive the second scanning mirror 134 are each contrived to have a lower inertia ratio and a higher resolution than the AC servomotors used to drive the arms of the multiple axis robot 110 in order to ensure that the expander lens 123 and the scanning mirrors 132 and 134 can be controlled quickly and precisely. Thus, the expander lens 123, the first scanning mirror 132, and the second scanning mirror 134 can be moved quickly and the laser beam can be shone accurately onto the working point. As a result, the welding quality can be improved, as well as the size, weight, and cost of the optical system of the scanner 120 can be reduced.

The AC servomotor 124 is connected to the expander lens 123 through the ball screw 125, which serves as a reduction gear having a large reduction ratio. The AC servomotor 124 moves the expander lens 123 very quickly and highly precisely. Therefore, the AC servomotor 124 has a low inertia ratio and a high resolution. Similarly, the rotary shaft of the AC servomotor 133 is connected to the first scanning mirror 132 through a reduction gear 133A having a large reduction ratio, and the rotary shaft of the AC servomotor 135 is connected to the second scanning mirror 134 through a reduction gear 135A having a large reduction ratio. Thus, in order to move the first and second scanning mirrors 132 and 134 quickly and precisely, the AC servomotor 133 and the AC servomotor 135 should have a low inertia ratio and a high resolution.

Thus, each of the expander lens 123, the first scanning mirror 132, and the second scanning mirror 134 is connected to a rotary shaft of an AC servomotor through a reduction gear having a high reduction ratio. Consequently, the expander lens 123, the first scanning mirror 132, and the second scanning mirror 134 can react quickly to the operation of the AC servomotors and the laser beam can be shone onto the working point in an accurate manner. As a result, the welding quality can be improved and the size, weight, and cost of the optical system of the scanner can be reduced.

More specifically, the laser beam must be scanned along each working point at a speed of 10 to 150 mm/sec and moved between working points at a speed of 3000 to 6000 mm/sec. In order to satisfy these requirements, the AC servomotors of the scanner 120 have far superior acceleration/deceleration performance and resolution in comparison to the AC servomotors of the multiple axis robot 110.

In order to achieve such a high acceleration/deceleration performance, the AC servomotors of the scanner 120 need experience only a very small amount of inertia during acceleration or deceleration. More specifically, the inertia ratio should be 1:1 or smaller as opposed to a normal inertia ratio of approximately 3:1.

Meanwhile, in order to achieve a high resolution, each of the AC servomotors of the scanner 120 is connected through a reduction gear having a high reduction ratio because the resolution with respect to the working point is insufficient when only a normal optical encoder is used. When such a reduction gear is used, it is necessary to reduce the effects of friction in the reduction gear as much as possible. Therefore, the reduction ratios of the reduction gears are set such that a maximum rated rotational speed of each of the AC servomotors corresponds to a beam movement speed of 3000 mm/sec to 6000 mm/sec at the working point.

The motors used in the multiple axis robot 110 and the motors used in the scanner 120 are AC servomotors. Using only AC servomotors enables a more uniform set of commands to be used. As a result, the robot control device 140 and the scanner control device 150 can be controlled at the same control speed and the same control cycle time with a single central processing unit 160.

More specifically, based on the operation (movement) commands issued from the central processing unit 16, the robot control device 140 can control the movements of the multiple axis robot 110 such that the multiple axis robot 110 traces a pre-taught path in an accurate manner. Meanwhile, based on operation commands issued from the central processing unit 160, the scanner control device 150 can control the scanner 120 such that the position where the laser beam is shone traces a pre-stored working point path. In short, the roles of the multiple axis robot 110 and the scanner 120 can be easily divided such that the position of the scanner 120 is controlled by the robot control device 140 and the working points are traced by the scanner 120. By dividing the roles in this way, the respective roles of the multiple axis robot 110 and the scanner 120 are clearly defined and the performance characteristics of the multiple axis robot 110 and the scanner 120 can be specialized so as to achieve an optimum apparatus structure.

Since the central processing unit 160 issues operation commands to the robot control device 140 and the scanner control device 150 at the same control cycle time and the same timing, the commands for the taught path of the multiple axis robot 110 and the commands for the working point path of the scanner 120 are synchronized. As a result, the scanner 120 can easily be operated while operating the multiple axis robot 110 and accurate, high-speed laser welding can be accomplished even if the work piece has a complex three-dimensional shape.

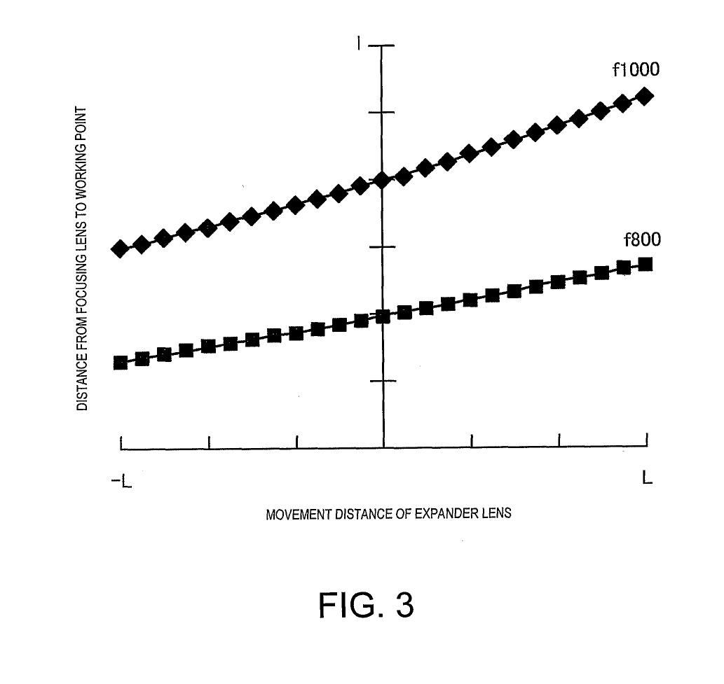

FIG. 3 is a plot illustrating a relationship between a movement distance of the expander lens 123 and a distance from the focusing lens 131 to a working point. In FIG. 3, the upper curve illustrates the relationship obtained when the expander lens 123 has a focal length of 1000 mm (f=1000) and the lower curve illustrates the relationship obtained when the expander lens 123 has a focal length of 800 mm (f=800). As is clear from FIG. 3, the relationship between the movement distance of the expander lens 123 and the distance from the focus lens 131 to a working point can be closely approximated with a second degree curve. This is true regardless of whether an expander lens 123 having a focal length of 1000 mm (f=1000) is used or an expander lens 123 having a focal length of 800 mm (f=800) is used. Both expander lenses 123 have a focal length error of approximately 1 mm.

If the beam quality of the laser beam emitted from the optical fiber 122 is 5 to 20 mm-mrad, then a focal point depth of 2 mm to 5 mm can be obtained in a vicinity of the working point. As a result, the error of the focal point position resulting from the secondary curve approximation will have substantially no effect on the laser welding.

Thus, if the origin of the coordinate system of the scanner 120 is set on the focusing lens 131 (which is a fixed element in the optical system), then the focal point distance can be approximated with a secondary curve when the focal point distance is varied by moving the expander lens 123. In this embodiment, the origin of the coordinate system of the scanner 120 is set on an intersection point between the focusing lens 131 and an optical axis of the laser beam in view of the fact that the focal point distance can be approximated with a secondary curve.

Even if the first and second scanning mirrors 132 and 134 are moved, the focal point distance can still be approximated with a second degree curve. Being able to approximate the focal point distance with a second degree curve makes it easier to position the multiple axis robot 110 on a taught path and easier to position the laser beam emitted from the scanner 120 onto the working point because the positions of the three axes of the scanner 120 with respect to the working point can be computed linearly. With a linear computation, the axes can be controlled easily in real time using a feedback control.

With the multiple axis robot 110, it is necessary to execute feedback control using forward kinematics and inverse kinematics in order to know the current position of a working end. When the origin of the coordinate system of the scanner 120 is set to lie on the focusing lens 131, which is fixed within the optical system, the current position of a working end of the multiple axis robot 110 can be computed accurately in a single computation, i.e., an analysis result is obtained in a single computation, using an inverse kinematics. Consequently, the computational load born by the robot control device 140 is reduced.

Conversely, if the origin of the coordinate system of the scanner 120 is set on an element that is not fixed within the optical system, e.g., the expander lens 123, the first scanning mirror 132, or the second scanning mirror 134, then an analysis result cannot be obtained in a single computation and the current position of the working end cannot be obtained with a single computation. Instead, it is necessary for the robot control device 140 to execute feedback control using repeated forward kinematics and inverse kinematics computations. Consequently, the computational load born by the robot control device 140 increases and the ability to perform high-speed welding work is diminished.

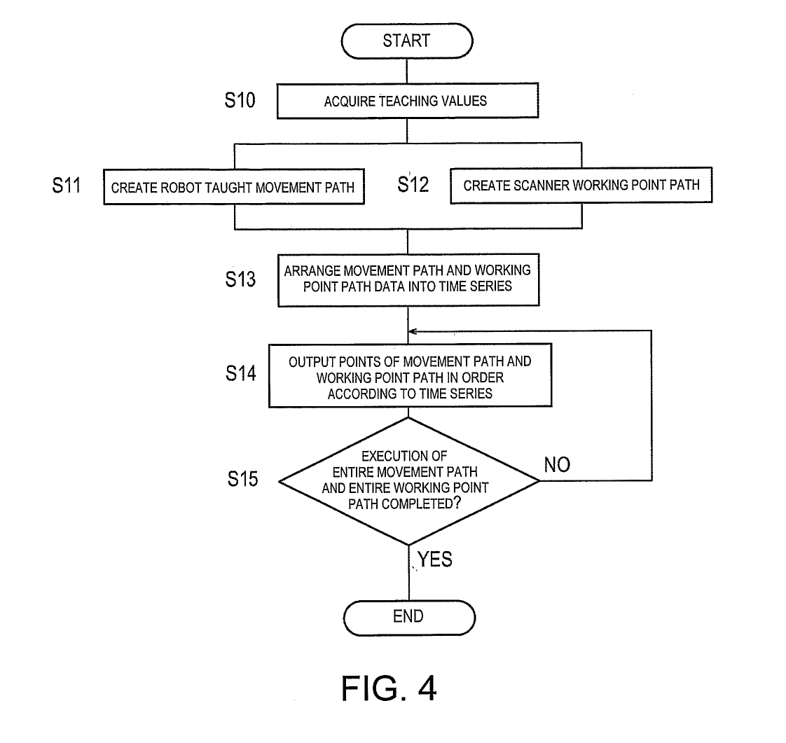

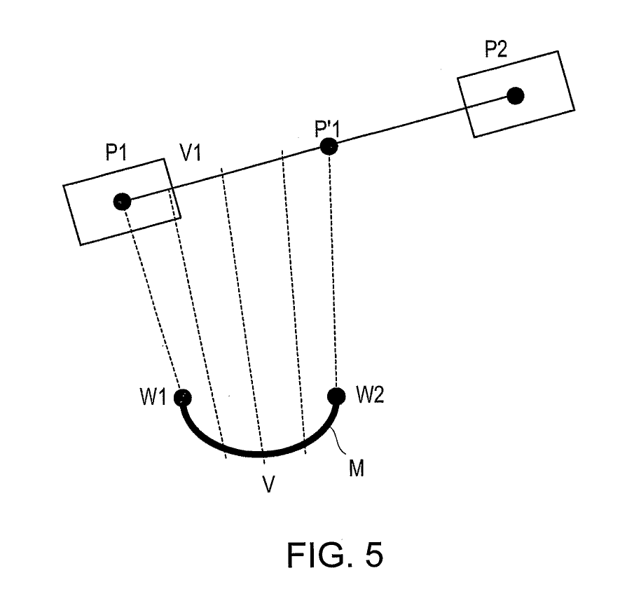

The operation of a laser welding apparatus according to the embodiment will now be explained with reference to the flowchart shown in FIG. 4 and the sketch shown in FIG. 5. FIG. 4 is a flowchart of control operations executed by a laser welding apparatus according to the embodiment, while FIG. 5 is a sketch used to explain the control processing presented in the flowchart shown in FIG. 4.

The operation flowchart is based on the assumption that a movement path of the multiple axis robot 110 and a working point path of the scanner 120 have already been taught. The process of teaching the path of the multiple axis robot 110 and the working point path of the scanner 120 will now be explained briefly.

The movement speed and response demanded when driving the arms of the multiple axis robot 110 are completely different from the movement speed and response demanded when driving the expander lens 123, the first scanning mirror 132, and the second scanning mirror 134 of the scanner 120. Therefore, a path for passing through working points is taught to the multiple axis robot 110 and a working point path for shining the laser beam onto working points is taught to the scanner 120.

The movement path of the multiple axis robot 110 and the working point path of the scanner 120 are taught separately and stored in the central processing unit 160.

The process of teaching the movement path and the working point path will now be explained in more detail with reference to FIG. 5. First, a starting point P1 of the movement path is taught to the multiple axis robot 110 and a starting point W1 of the working point path is taught to the scanner 120. Next a movement position (point) P2 and a movement speed V1 for moving from the point P1 to the point P2 are taught to the multiple axis robot 110. At the same time, a path M of working points to be traced by the scanner 120 (semicircular path shown in FIG. 5), a finishing point W2, and a working (laser beam movement) speed V are taught to the scanner 120.

The speed V1 at which the multiple axis robot 110 moves from the point P1 to the point P2 is set independently of the working speed V of the scanner 120. It is preferable to set the movement speed V1 and the working speed V such that the scanner 120 finishes the laser welding while the multiple axis robot 110 is moving from the point P1 to the point P2.

The operation of a laser welding apparatus according to the embodiment will now be explained based on the flowchart of FIG. 4.

In step S10, the central processing unit 160 acquires teaching values for the multiple axis robot 110 and the scanner 120 from an internal storage device. More specifically, the central processing unit 160 acquires a starting point P1, an ending point P2 and a movement speed V1 for the robot 110, all of which have been stored in the storage device in advance. Also the central processing unit 160 acquires a starting point W1, an ending point W2 and a working speed V for the scanner 120, all of which have been stored in the storage device in advance.

In step S11, the central processing unit 160 creates a taught movement path for the multiple axis robot 110 based on the teaching values for the multiple axis robot 110 obtained from the storage device. More specifically, the central processing unit 160 creates passage points (three points between the points P1 and P2 to which dotted lines are drawn in FIG. 5) corresponding to each control cycle of the robot control device 140.

In step S12, the central processing unit 160 creates a taught working point path for the scanner 120 based on the teaching values for the scanner 120 obtained from the storage device. More specifically, the central processing unit 160 creates passage points (three points between the points W1 and W2 to which dotted lines are drawn in FIG. 5) corresponding to each control cycle of the scanner control device 150.

In step S13, the central processing unit 160 arranges the points of the movement path for the multiple axis robot 110 into a time series and arranges the points of the working point path for the scanner 120 created in step S12 into a time series.

In step S14, the central processing unit 160 sends the time series of the movement path for the multiple axis robot 110 to the robot control device 140 and the time series of the taught path for the scanner 120 to the scanner control device 150.

The robot control device 140 sends the movement path received from the central processing unit 160 to the multiple axis robot 110 at the same control cycle time and the same timing, thereby positioning the multiple axis robot 110 along the movement path between the points P1 and P2. Meanwhile, the scanner control device 150 sends the working point path received from the central processing unit 160 to the scanner 120 at the same control cycle time and the same timing, thereby scanning the laser beam along the working point path between the points W1 and W2. In other words, the points of the movement path are sent to the robot 110 at the same time as the points of the working point path are sent to the scanner 120 such that the robot 110 and the scanner 120 move in a synchronized manner.

As shown in FIG. 5, while the laser beam moves from the point W1 to the point W2 along the working point path M, the multiple axis robot 110 only moves from the point P1 to a point P′1 along the movement path and still has a small distance remaining before it reaches the point P2 after the welding is finished.

In step S15, the central processing unit 160 determines if the entire movement path and the entire working point path have been completed. If the entire movement path and the entire working point path have not been completed (result of step S15 is No), then the central processing unit 160 continues to execute step S14. That is, the central processing unit 160 continues to execute step S14 if the laser beam has not moved from point W1 to W2 and completed welding of the working point path M and the multiple axis robot 110 has not moved from the point P1 to the point P2 of the movement path. Meanwhile, the entire movement path and the entire working point path have been completed (result of step S15 is Yes), then the central processing unit 160 ends laser welding.

Some possible effects that can be obtained with a laser welding apparatus according to this embodiment are listed below.

Since an origin of a coordinate system of the scanner is set to coincide with an intersection point between an optical axis of the laser beam and an element among the constituent elements of the optical system that is fixed, the control of the multiple axis robot is simpler and the multiple axis robot can trace taught points accurately and at a high speed.

Since the multiple axis robot is controlled by a robot control device, the scanner is controlled by a scanner control device, and the robot control device and the scanner control device are contrived to issue operation commands at the same control cycle time and the same timing, the operations (movements) of the multiple axis robot and the operations of the scanner are controlled separately but in such a manner that the operations can be easily synchronized. As a result, the apparatus can accomplish laser welding work at a high speed with a high degree of precision.

By controlling (moving) the expander lens and the two scanning mirrors in accordance with the three-dimensional coordinates of the working points, the laser beam can be controlled to accomplish accurate laser welding on a work piece whose working points vary in three dimensions.

Since the motors used to drive the expander lens and the two scanning mirrors have a lower inertia ratio and a higher resolution than the motors used to drive the arms of the multiple axis robot, the laser beam can be shone onto the working points in an accurate fashion. As a result, the welding quality can be improved and the size, weight, and cost of the optical system of the scanner can be reduced.

Using only AC servomotors enables a more uniform set of commands to be used. As a result, the robot control device and the scanner control device can be controlled at the same control speed and the same control cycle time with a single central processing unit.

Each of the expander lens and the two scanning mirrors is connected to a rotary shaft of the respective AC servomotor through a reduction gear having a high reduction ratio. Consequently, the expander lens and the two scanning mirrors can react quickly to the operation of the AC servomotors and the laser beam can be shone onto the working points in an accurate manner. As a result, the welding quality can be improved and the size, weight, and cost of the optical system of the scanner can be reduced.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A laser welding apparatus comprising:
a multiple axis robot having an arm; and
a scanner attached to a tip end of the arm of the multiple axis robot, with the scanner including an optical system that emits a laser beam onto a work piece,
the scanner includes a preset coordinate system with an origin of the coordinate system coinciding with an intersection point between an optical axis of the laser beam and a fixed element of the optical system.

2. The laser welding apparatus as recited in claim 1, wherein
the fixed element of the optical system is a focusing lens.

3. The laser welding apparatus as recited in claim 1, further comprising
a robot control device that controls operations of the multiple axis robot to move the arm along a taught movement path such that the origin of the coordinate system of the scanner moves along the taught movement path; and
a scanner control device that controls operations of the optical system of the scanner such that the laser beam is emitted onto a working point of the work piece.

4. The laser welding apparatus as recited in claim 3, further comprising
a central processing unit that issues operation commands such that the robot control device and the scanner control device operate in a synchronized fashion.

5. The laser welding apparatus as recited in claim 1, wherein
the optical system of the scanner further includes
an expander lens that adjusts a focal point distance by moving along an optical axis direction of the laser beam;
a collimating lens that collimates the laser beam exiting the expander lens; and
a pair of scanning mirrors that scans the laser beam exiting the collimating lens on the work piece.

6. The laser welding apparatus as recited in claim 5, wherein
the expander lens is connected to a rotary shaft of a motor;
the scanning mirrors are each connected to a rotary shaft of a motor; and
each of the motors has a lower inertia ratio and a higher resolution than a motor used to drive the arm of the multiple axis robot.

7. The laser welding apparatus as recited in claim 6, wherein
the motors that drive the expander lens and the scanner mirrors are AC servomotors, with the expander lens and the scanning mirrors each being connected to a rotary shaft of a respective one of the AC servomotors through a reduction gear having a high reduction ratio.

8. The laser welding apparatus as recited in claim 5, wherein
the optical system of the scanner uses a linear approximation for a computation of a movement amount of the expander lens in the optical axis direction of the laser beam and for a computation of a change amount of the focal point distance.

9. The laser welding apparatus as recited in claim 7, wherein
the optical system of the scanner uses a linear approximation for a computation of a movement amount of the expander lens in the optical axis direction of the laser beam and for a computation of a change amount of the focal point distance.

10. The laser welding apparatus as recited in claim 9, wherein
the fixed element of the optical system is a focusing lens.

11. The laser welding apparatus as recited in claim 10, further comprising
a robot control device that controls operations of the multiple axis robot to move the arm along a taught movement path such that the origin of the coordinate system of the scanner moves along the taught movement path; and
a scanner control device that controls operations of the optical system of the scanner such that the laser beam is emitted onto a working point of the work piece.

12. The laser welding apparatus as recited in claim 11, further comprising
a central processing unit that issues operation commands such that the robot control device and the scanner control device operate in a synchronized fashion.

13. The laser welding apparatus as recited in claim 5, wherein
the fixed element of the optical system is a focusing lens.

14. The laser welding apparatus as recited in claim 5, further comprising
a robot control device that controls operations of the multiple axis robot to move the arm along a taught movement path such that the origin of the coordinate system of the scanner moves along the taught movement path; and
a scanner control device that controls operations of the optical system of the scanner such that the laser beam is emitted onto a working point of the work piece.

15. The laser welding apparatus as recited in claim 14, further comprising
a central processing unit that issues operation commands such that the robot control device and the scanner control device operate in a synchronized fashion.
